(19) United States
(12) Patent Application Publication
(10) Pub. No.: US 2015/0071539 A1
(43) Pub. Date: Mar. 12, 2015

(54) Invariant Relationship Characterization for Visual Objects

(71) Applicant: International Business Machines Corporation, Armonk, NY (US)

(72) Inventor: Pavel Kisilev, Maalot (IL)

(73) Assignee: International Business Machines Corporation, Armonk, NY (US)

(21) Appl. No.: 14/020,920

(22) Filed: Sep. 9, 2013

(51) Int. Cl. G06K 9/46

(52) U.S. Cl. CPC G06K 9/4642
USPC 382/170

(57) ABSTRACT

Machines, systems and methods for object relationship characterization are provided. The method comprises providing a plurality of images, each having a plurality of pixels; selecting a pair of images from the plurality of images, the pair of images comprises a first image and a second image; characterizing at least one pixel of the first image and the second image by a first feature vector and a second feature vector respectively; characterizing the first image by a first probability distribution over the first feature vector; characterizing the second image by a second probability distribution over the second feature vector; assigning a list of histogram bins for the first image and the second image; computing a distribution flow descriptor (DFlow) for capturing relationship between the first probability distribution and the second probability distribution.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to relationship characterization between objects and, more particularly, to a system and method for invariant inter-and intra-object relationship description and characterization between pairs of object classes.

### BACKGROUND

Image recognition and classification schemes may be based on contextual information in images. Such classification may be used to enable expedited or enhanced selection and retrieval of important or relevant image features from the image content. Image features may be acquired and classified based on image descriptors. Image descriptors can be used to help establish a connection between pixels contained in one or more digital images hereafter also referred to as objects.

Visual descriptors may be divided in two main groups: (1) general domain descriptors that provide information about color, shape, regions, textures and motion in an object, and (2) specific domain descriptors that provide information about objects and events in a scene. A special image descriptor typically can be used to help with recognition of the particular object from which the descriptor is extracted but it is not relevant to recognition of other objects.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, machines, systems and methods for object relationship characterization are provided. The method comprises providing a plurality of images, each having a plurality of pixels; selecting a pair of images from the plurality of images, the pair of images comprises a first image and a second image; characterizing at least one pixel of the first image and the second image by a first feature vector and a second feature vector respectively; characterizing the first image by a first probability distribution over the first feature vector; characterizing the second image by a second probability distribution over the second feature vector; assigning a list of histogram bins for the first image and the second image; computing a distribution flow descriptor (DFlow) for capturing relationship between the first probability distribution and the second probability distribution.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates a flow diagram of an exemplary method for object relationship characterization in accordance with one or more embodiments.

FIG. 2 illustrates the computation of a distribution flow (DFlow) descriptor for capturing relationship between the first probability distribution and the second probability distribution.

FIGS. 3A through 3D illustrate a distribution flow descriptor (DFlow) and a displacement descriptor (DField) for the two images shown, in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one embodiment, a method for invariant object relationship characterization is proposed. The method may utilize a distribution flow (DFlow) feature and a displacement field (DField) feature to characterize relationships between or within objects. In one implementation, the DFlow feature and the DField feature may utilize a transportation algorithm to compute the relationship between a pair of images or a pair of objects. It is noteworthy that the terms “image” and “object” in this disclosure are used interchangeably.

DFlow of an image may be presented as a two-dimensional matrix where the values in the matrix represent the weight that is moved from a histogram bin implemented for the first object to a histogram bin implemented for the second object. A histogram is a graphical representation of the distribution of data that provides an estimate of the probability distribution of a continuous variable. The histograms for the objects may be obtained from linear program optimization.

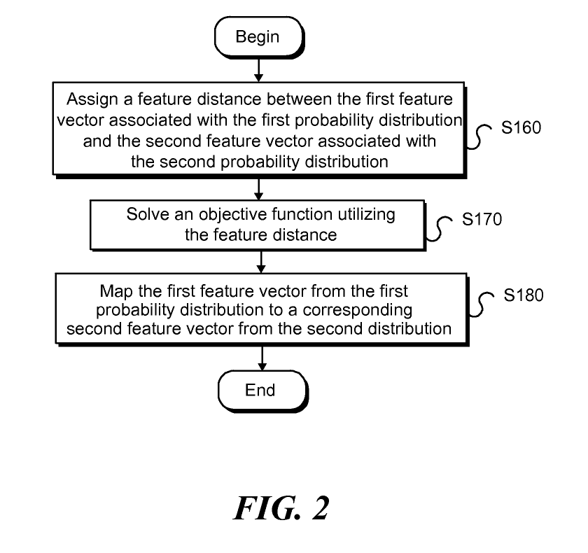

Dfield of an image may be calculated based on a projection of Dflow as the average of the sum of the rows in the histogram with the purpose of translating the result obtained from the DFlow to a smooth descriptor which averages the weights for a particular bin in the object into a one dimensional metric, as provided in further detail below with reference to FIGS. 2A through 2D.

In one embodiment, to evaluate a transformation between a pair of objects, a histogram of values including the frequencies of appearance of particular pixel values (e.g., RGP values) in each object is separately generated. As such, a first histogram associated with the first object and a second histogram associated with the second object are obtained. The histograms provide an indication of the frequency of appearance of the characteristic in each image. DFlow and DField may be calculated for the two objects based on the histograms.

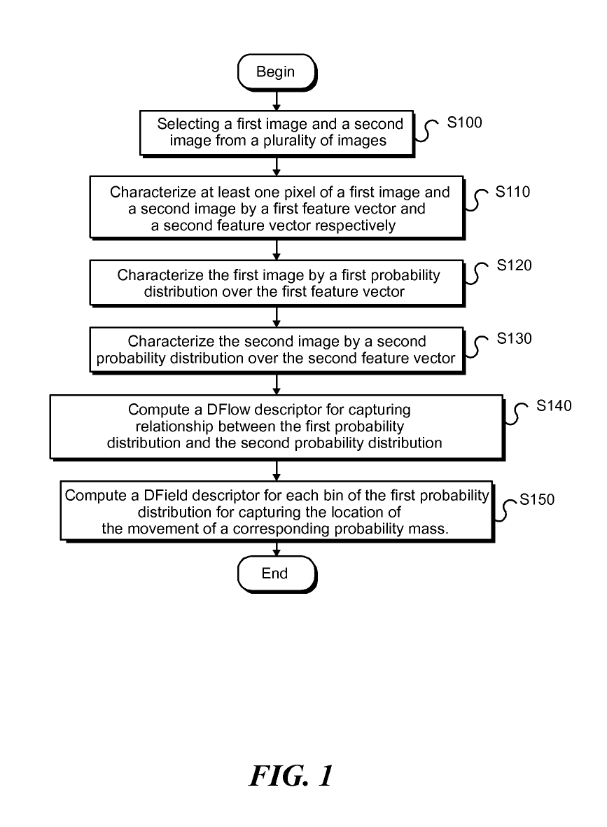

Referring to FIG. 1, a pair of images (i.e., a first image and a second image) may be selected from among a plurality of images (S100). At least one pixel from the first image may be characterized by a first feature vector and at least one pixel in the second image may be characterized by a second feature vector (S110). Pixels in images (or objects) may be characterized by zεR^{d}, where “z” is the feature vector, such that “z” is a real (R) feature vector of dimension d (i.e., the feature vector “z” contains “d” real numbers). The DFlow descriptor and the DField descriptor may be the descriptors for a pair of images or a pair of objects.

An object or image, in its entirety, is then characterized by a probability distribution over “z”. For simplicity, we assume discrete distributions or histograms for the two images (or objects), which may be written compactly as a list of histogram bins with nonzero probability. The DFlow feature may be used to capture the relationship between two probability distributions. The first image may be characterized by a first probability distribution over the first feature vector (S120) and the second image may be characterized by a second probability distribution over the second feature vector (S130).

Upon characterization, the DFlow descriptor assigns a list of histogram bins for the first image and for the second image. In one implementation, the list of histograms may be represented as { [symbol] (z) [symbol] _{⊥}i, pᵢ^{k})} iⁿ=1, where zᵢ, is a bin center, pᵢ^{k} is the corresponding probability mass for that bin for the k^{th} probability distribution. In an exemplary implementation, k takes the value 1 for the first probability distribution and takes the value 2 for the second probability distribution and n is the number of such bins. In one implementation, both the number of bins and the bin centers may be fixed across the two probability distributions.

In accordance with one aspect, in order to capture relationship between the first probability distribution and the second probability distribution, a DFlow descriptor, fᵢⱼ is computed (S140), where the indices i and j range over the (non-empty) bins of the first and second probability distributions respectively. Accordingly, fᵢⱼ may be thought of as the part of bin i from the first probability distribution which is mapped to bin j of the second probability distribution. Upon computing the DFlow descriptor, the DField descriptor is computed for each bin of the first probability distribution for capturing the location of the movement of a corresponding probability mass (S150).

Referring to FIG. 2, to compute the DField descriptor, a feature distance between the first feature vector associated with the first probability distribution and the second feature vector associated with the second probability distribution is assigned (S160). The feature distance may be defined as D(z₁, z₂). In one implementation, utilizing said feature distance, an objective function may be solved (S170). The objective function may be represented as:

$${min}_{( {f}_{ij} )} {\sum }_{i = 1}^{n} {\sum }_{j = 1}^{n} {f}_{ij} D ( {z}_{i}^{1} , {z}_{j}^{2} )$$

$$subject to$$

$${\sum }_{j = 1}^{n} {f}_{ij} \text{?} = {p}_{i}^{1} i = 1 , … , n$$

$$and$$

$${\sum }_{i = 1}^{n} {f}_{ij} \text{?} {p}_{j}^{2} j - 1 , … , n$$

$$\text{?} \text{indicates text missing or illegible when filed}$$

In accordance with one embodiment, the goal of the objective function may be to map the first feature vector from the first distribution zᵢ¹ to corresponding second feature vector from the second distribution zⱼ² in such a way that the feature distance between these feature vectors is within a target range (e.g., as small as possible) (S180). A bin of the first probability distribution may map to more than one bin of the second probability distribution. The bins from the first probability distribution may be spread over several bins from the second probability distribution, subject to constraints which ensure conservation of probability for both the first and second distributions.

Accordingly, the DField descriptor captures, for a bin, where the bin's probability mass moves. The DField descriptor for bin i of the first probability distribution may be computed by

$${δ}_{i} = {\sum }_{j} {f}_{ij} ( {z}_{j} - {z}_{i} ) ,$$

where zⱼ−zᵢ is the displacement bin i undergoes (in feature space) in moving to bin j (S150). In one instance, the Dfield descriptor, δᵢ may be like an expected displacement in a feature space. The value of DField descriptor defined by δᵢ indicates how the bins of the first probability distribution are to move in order to transform into the second probability distribution.

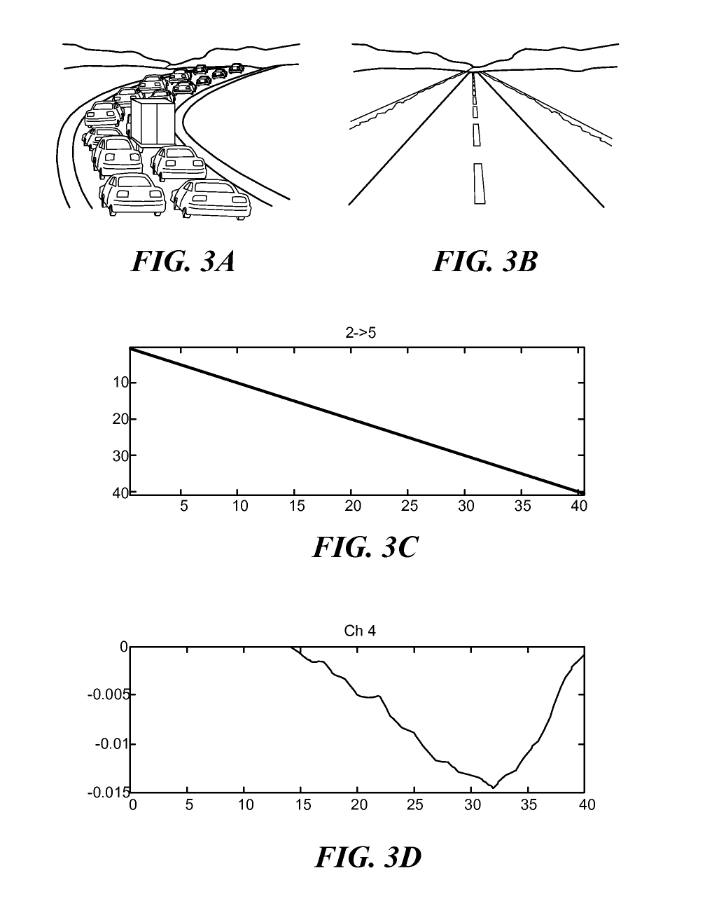

Referring to FIGS. 3A through 3D, the computation of the DFlow descriptor and the DField descriptor for two images in accordance with one embodiment is illustrated. FIG. 3A shows a road with a heavy traffic and FIG. 3B shows a road without any traffic. The DFlow descriptor of the two images is computed and represented in FIG. 3C. Similarly, the Dfield descriptor for the two images is represented in FIG. 3D. It is noteworthy that, in the above scenario, the DFlow descriptor and the DField descriptor are computed from histograms of texture based features of the two images. The DField descriptor reveals a negative dip, which indicates there is less texture in the non-traffic image, as compared to traffic image.

Advantageously, in accordance with one embodiment, the DFlow descriptor and the DField descriptor may be utilized for inter-class relationship characterization and for intra-class relationship characterization. In inter-class relationship characterization, the DFlow descriptor or DField descriptor may describe the relationship between two classes of images. For example, if A and B are two classes of images (e.g., paintings by two different illustrators or artists), then, the DFlow descriptor between two images of the class A may be fᵢⱼ^{AA′} and the DFlow descriptor between two images of the class A and class B may be fᵢⱼ^{AB}. In this example, fᵢⱼ^{AA′} and fᵢⱼ^{AB} would differ significantly from each other. Furthermore, if two training sets of DFlow descriptors, fᵢⱼ^{AA′} and fᵢⱼ^{AB} are given, a learning algorithm may learn to classify any new pair as either AA′ or AB.

In intra-class relationship characterization, the DFlow descriptor and DField descriptor are used to characterize a single class of objects. This relationship-based approach characterizes feature points within an object. In one implementation, based on the presence of these feature points and accompanying DFlow descriptor or DField descriptor, a standard Bag of Visual Words approach or any similar approach of that kind may be used to perform object recognition. In order to compute the feature points and associated DFlow and DField descriptors, an edge detector may be run within the image or region of interest in the image. For a sufficiently strong edge-response, a target area may be selected centered at an edge point, with for example a fixed small radius.

In one implementation, the target area (e.g., in the shape of a circle) may be partitioned into two halves (e.g., optionally or preferably halves of even proportions) using an estimated direction of the edge. Depending on implementation, other partitioning methods may be utilized. In this example, for each of the two halves with k=1, 2, a distribution pᵢ^{k} may be computed. The DFlow fᵢⱼ between the two distributions pᵢ¹ and p_{z}^{h} is the descriptor for the feature point. Alternatively, the DField δᵢ based on the DFlow fᵢⱼ may be used as the descriptor.

Accordingly, in the standard Bag of Visual Words approach, for a given training set on which one has collected the DFlow or DField descriptors for a feature point, a vector quantization is performed on the collection of descriptors. If the vector quantization is into L possibilities, then each object in the training set is characterized by a histogram of size L, based on how many of each type of descriptor exists in the object.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

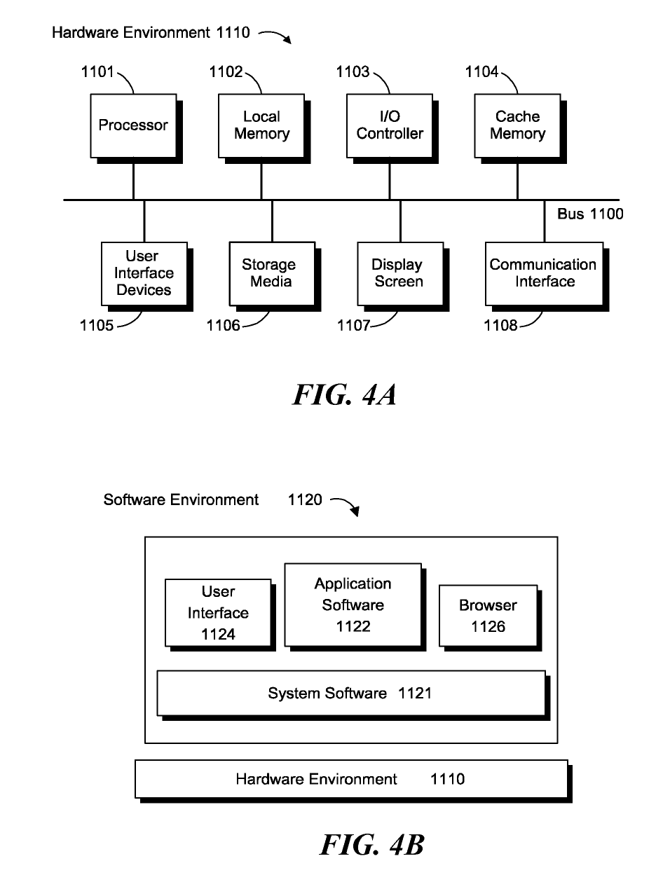

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-Ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that may contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for object relationship characterization, the method comprising:
providing a plurality of images having a plurality of pixels;
selecting a pair of images from the plurality of images, wherein the pair of images comprises a first image and a second image;
characterizing at least one pixel of the first image and one pixel of the second image by a first feature vector and a second feature vector, respectively;
characterizing the first image by a first probability distribution over the first feature vector;
characterizing the second image by a second probability distribution over the second feature vector;
assigning a list of histogram bins for the first image and the second image;
computing a distribution flow descriptor (DFlow) for capturing a relationship between the first probability distribution and the second probability distribution by:
assigning a feature distance between the first feature vector associated with the first probability distribution and the second feature vector associated with the second probability distribution; and
solving an objective function utilizing the feature distance; and
mapping the first feature vector from the first probability distribution to a corresponding second feature vector from the second probability distribution.

2. The method of claim 1, wherein after the DFlow descriptor is computed, computing a displacement field (DField) descriptor for each bin of the first probability distribution for capturing the location of the movement of a corresponding probability mass is performed.

3. The method of claim 1, wherein the DFlow descriptor and the DField descriptor are descriptors of the pair of images or a pair of objects.

4. The method of claim 1, wherein the DFlow descriptor and the DField descriptor are configured to characterize relationships between images or objects or relationships within images or objects.

5. The method of claim 1, wherein the first feature vector and the second feature vector are defined as zεR^{d}.

6. The method of claim 1, wherein the list of histogram bins for the first and the second images is defined as { [symbol] (z) [symbol] ₗi, pᵢ^{k})} iⁿ=1, where zᵢ is a bin center, is the corresponding probability mass of zᵢ for the k^{th} probability distribution, k=1 for the first probability distribution and k=2 for the second probability distribution, n is the number of histogram bins.

7. The method of claim 1, wherein the DFlow descriptor between the first probability distribution and the second probability distribution is fᵢⱼ, where i and j range over the histogram bins of the first and the second probability distributions respectively.

8. The method of claim 7, wherein the DFlow descriptor is a part of bin i from the first probability distribution which is mapped to bin j of the second probability distribution.

9. The method of claim 1, wherein the feature distance is D (z₁, z₂).

10. The method of claim 1, wherein the objective function is
$${min}_{( {f}_{ij} )} {\sum }_{i = 1}^{n} {\sum }_{j = 1}^{n} {f}_{ij} D ( {z}_{i}^{1} , {z}_{j}^{2} )$$
$$subject to$$
$${\sum }_{j = 1}^{n} {f}_{ij} \text{?} = {p}_{i}^{1} i = 1 , … , n$$
$$and$$
$${\sum }_{i = 1}^{n} {f}_{ij} \text{?} = {p}_{j}^{2} j = 1 , … , n$$
$$\text{?} \text{indicates text missing or illegible when filed}$$
where zᵢ¹ is the first probability distribution, zⱼ² is the second probability distribution.

11. The method of claim 1, wherein the DField descriptor is defined as:
$${δ}_{i} = {\sum }_{j} {f}_{ij} ( {z}_{j} - {z}_{i} ) ,$$
where zⱼ−zᵢ is a displacement bin i when moving towards bin j.

12. A system for characterizing object relationship between a plurality of images, the system comprising:
a logic unit for providing the plurality of images;
a logic unit for selecting a pair of images from the plurality of images, the pair of images comprising a first image and a second image;
a logic unit for characterizing the first image by a first feature vector and the second image by a second feature vector, and the first image by a first probability distribution and the second image by a second probability distribution;
a logic unit for assigning a list of histograms bins for the first image and the second image;
a logic unit for computing a distribution flow (DFlow) descriptor for capturing relationship between the first probability distribution and the second probability distribution;
a logic unit for assigning a feature distance between the first feature vector and the second feature vector;
a logic unit for solving an objective function utilizing the feature distance;
a logic unit for mapping the first feature vector to the second feature vector; and
a logic unit for computing a displacement field (DField) descriptor for a bin of the first probability distribution for capturing the location of the movement of a corresponding probability mass.

13. The system of claim 12, wherein the DFlow descriptor and the DField descriptor are descriptors of the pair of images or a pair of objects.

14. The system of claim 12, wherein the DFlow descriptor and the DField descriptor are configured to characterize relationships between images/objects and relationships within images/objects.

15. The system of claim 12, wherein the first feature vector and the second feature vector are defined as zεR^{d} and the feature distance is defined as D(z₁, z₂).

16. The system of claim 12, wherein the list of histogram bins for the first image and the second image is defined as {zᵢ, pᵢ^{k})}iⁿ=1, where zᵢ is a bin center, pᵢ^{k} is the corresponding probability mass of zᵢ for the k^{th} probability distribution, n is the number of histogram bins.

17. The system of claim 12, wherein the objective function is
$${min}_{( {f}_{ij} )} {\sum }_{i = 1}^{n} {\sum }_{j = 1}^{n} {f}_{ij} D ( {z}_{i}^{1} , {z}_{j}^{2} )$$
$$subject to$$
$${\sum }_{j = 1}^{n} {f}_{ij} \text{?} = {p}_{i}^{1} i = 1 , … , n$$
$$and$$
$${\sum }_{i = 1}^{n} {f}_{ij} \text{?} = {p}_{j}^{2} j = 1 , … , n$$
$$\text{?} \text{indicates text missing or illegible when filed}$$
where fᵢⱼ is the DFlow descriptor between the first probability distribution and the second probability distribution, zᵢ¹ is the first probability distribution, zⱼ² is the second probability distribution.

18. The system of claim 12, wherein the DField descriptor is defined as
$${δ}_{i} = {\sum }_{j} {f}_{ij} ( {z}_{j} - {z}_{i} ) ,$$
where fᵢⱼ is the probability distribution, zⱼ−zᵢ is a displacement bin i when moving towards bin j.

19. A computer program product comprising a computer readable storage medium having a computer readable program, wherein the computer readable program when executed on a computer causes the computer to:
provide a plurality of images, each having a plurality of pixels;
select a pair of images from the plurality of images, the pair of images comprising a first image and a second image;
characterize at least one pixel of the first image and at least one pixel of the second image by a first feature vector and a second feature vector, respectively;
characterize the first image by a first probability distribution over the first feature vector;
characterize the second image by a second probability distribution over the second feature vector;
assign a list of histogram bins for the first image and the second image;
compute a distribution flow (DFlow) descriptor for capturing relationship between the first probability distribution and the second probability distribution;
assign a feature distance between the first feature vector associated with the first probability distribution and the second feature vector associated with the second probability distribution;
solve an objective function utilizing the feature distance;
map the first feature vector from the first probability distribution to a corresponding second feature vector from the second probability distribution; and
compute a displacement field (DField) descriptor for each bin of the first probability distribution for capturing the location of the movement of a corresponding probability mass.

20. The computer program product of claim 19, wherein the DFlow descriptor and the DField descriptor are configured to characterize relationships between images/objects and relationships within images/objects.
